(19) United States
(12) Patent Application Publication
(10) Pub. No.: US 2024/0023601 A1
(43) Pub. Date: Jan. 25, 2024

(54) ELECTROMAGNETIC HEATER FOR HEATING HOOKAH AND ELECTROMAGNETIC HEATING DEVICE FOR HOOKAH

(71) Applicant: DONGGUAN MYSMOK ELECTRONIC TECHNOLOGY CO, LTD., Dongguan City (CN)

(72) Inventor: LIQING HE, Dongguan City (CN)

(21) Appl. No.: 17/936,841

(22) Filed: Sep. 29, 2022

(30) Foreign Application Priority Data
Jul. 22, 2022 (CN) 202210876149.0

(51) Int. Cl. A24F 1/30; A24F 1/24; H05B 3/74

(52) U.S. Cl. CPC A24F 1/30; A24F 1/24; H05B 3/748

(57) ABSTRACT

An electromagnetic heater for hookah includes a shell and an electromagnetic heating body, the shell includes a heat-insulating base plate, and the electromagnetic heating body includes an excitation coil and a drive circuit, the excitation coil is in a shape of a sheet and formed by spiraling a wire outward from a center, and the excitation coil is configured to face the heat-insulating base plate and send out a high-frequency AC signal by which an eddy current effect is produced on an electromagnetic induction element to the heat-insulating base plate, under a control of the drive circuit. The heater applying to the hookah can increase the heating efficiency, the safety and the reliability.

### FIELD OF THE INVENTION

The invention relates to the field of hookah heating, in particular to an electromagnetic heater and an electromagnetic heating device for hookah.

### BACKGROUND OF THE INVENTION

Hookahs originated in India and are mainly popular in Arab countries. Referring to FIG. 1, a hookah generally includes a hookah bowl 11 for containing shredded tobacco 10 or tobacco paste, a hookah bottle 12 for containing filtered water, and a hookah pipe 122 formed at a side wall of the hookah bottle 12. The hookah bowl 11 is provided with an air pipe 111 at the bottom, and a filtering pipe 13 is communicated with the air pipe 11 and the filtered water in the hookah bottle 12, respectively. When in use, filtered water 121 with a certain amount is filled in the hookah bottle 12, and the hookah bowl 11 is then placed on the hookah bottle 12, with the air pipe 111 is inserted into the filtering pipe 13. A silicone sealing gasket 14 is arranged between the hookah bowl 11 and the upper part of the hookah bottle 12. Next, the shredded tobacco 10 is placed in the hookah bowl 11, and the opening of the hookah bowl 11 is wrapped with a small piece of tin foil where some air holes are poked, and then burning charcoal is placed on the tin foil. A smoking pipe 15 is inserted into hookah pipe 122 and can be sucked on for smoking the hookah. Specifically, the shredded tobacco 10 is heated and burnt due to the burning charcoal, when the smoking pipe 15 is sucked on, air enters the hookah bowl 11 via the air holes on the tin foil, and then is filtered in the filtered water 121, and finally enters user's mouth.

However, such a traditional hookah heating manner is complicated, and furthermore the temperature of the charcoal is uncontrollable. On the other hand, harmful gas or smokes will be produced due to charcoal burning, which is harmful to human body after inhalation, and also leads to contaminant to the environment or brings fire hazard.

For these issues, Chinese patent CN203952409U discloses an electrically heated hookah bowl. A metal tube is directly arranged at the bottom of the hookah bowl, on which a coil is wound. When in use, the coil is energized to heat the metal tube, thereby heating and burning the shredded tobacco. However, it's difficult to clean the hookah bowl with such a structure, to cause smoke stains accumulated in the bowl. Meanwhile, the heating efficiency is low since the heating source is configured at the bottom of the bowl, and it's difficult for the air to uniformly enter the shredded tobacco to lead to bad uniformity of the tobacco burning, especially during the initial smoking.

Chinese patent application CN101483942A discloses a hookah electronic charcoal, which uses high thermal conductivity ceramics to replace the hookah charcoal. When in use, on one hand, the air holes in the foil will be blocked, causing it difficult for air to enter the hookah bowl, which limits the smoking amount; on the other hand, the foil is firstly heated through the thermal conductivity, and then the shredded tobacco is heated, which results in a poor heating efficiency. For this, a bulky transformer will possibly be required to enhance the power to increase the heating efficiency.

Therefore, there is an urgent need for an improved hookah heating device to solve the above problems.

### SUMMARY OF THE INVENTION

The purposes of the present invention are to provide an electromagnetic heater for heating hookah and an electromagnetic heating device for hookah, to increase the heating efficiency, the safety and the reliability.

As a first aspect of the present invention, an electromagnetic heater for heating hookah includes a shell and an electromagnetic heating body installed in the shell, the shell includes a heat-insulating base plate, and the electromagnetic heating body includes an excitation coil and a drive circuit, the excitation coil is in a shape of a sheet and formed by spiraling a wire outward from a center, the excitation coil is configured to face the heat-insulating base plate and send out a high-frequency AC signal by which an eddy current effect is produced on an electromagnetic induction element to the heat-insulating base plate, under a control of the drive circuit.

Preferably, a plurality of support legs for supporting the shell are protruded on the heat-insulating base plate, the support legs are supported on a hookah bowl, and an air inlet is formed between the heat-insulating base plate and the hookah bowl and communicated with the hookah bowl.

Preferably, the support legs are configured near an outer edge of the heat-insulating base plate and distributed around a center of the heat-insulating base plate, and a heating area is defined on the heat-insulating base plate.

Preferably, an outer protruding portion is protruded from a middle of the heat-insulating base plate, and a backside of the outer protruding portion is recessed to accommodate the excitation coil.

Specifically, the outer protruding portion has a horizontal plate lower than ends of the support legs, the support legs are configured near an outer edge of the heat-insulating base plate and distributed around a center of the heat-insulating base plate, and the outer protruding portion is inserted into the hookah bowl when the support legs are supported on the hookah bowl.

More specifically, multiple guide bumps are provided along a periphery of the outer protruding portion, the guide bumps and the support legs are arranged in a staggered manner; a distance between an outer side of each guide bump and a center of the heat-insulating base plate is greater than or equal to that between an inner side of each support leg and the center of the heat-insulating base plate, and is less than that between an outer side of each support leg and the center of the heat-insulating base plate, and an outer end of each guide bump is inclined to form a guide wall.

Preferably, the heater further includes a heat-resistant cover removable from the hookah bowl, wherein an upper surface of the heat-resistant cover is recessed to form an accommodating cavity, a bottom wall of the accommodating cavity is provided with a through hole, a middle of the heat-insulating base plate is provided with an outer protruding portion that is engaged with the accommodating cavity, the shell is movably supported on the heat-resistant cover, the outer protruding portion is inserted into the accommodating cavity, and an air inlet is formed between the heat-resistant cover and the heat-insulating base plate to communicate with external environment and the through hole, respectively.

Preferably, the electromagnetic heating body further comprises a control unit for controlling operations of the drive circuit and a power supply unit for supplying power to the drive circuit; the shell comprises a top shell, a bottom shell, and an isolation cover installed between the top shell and the bottom shell, a first chamber for installing the control unit and the power supply unit is formed between the top shell and the isolation cover, and a second chamber for installing the excitation coil is formed between the isolation cover and the bottom shell, and the first chamber is isolated from the second chamber by the isolation cover; the heat-insulating base plate forms a bottom wall of the top shell, and a middle of the isolation cover is recessed toward the second chamber to form an isolation cavity, a side of the isolation cover opposite to the isolation cavity is provided with an inner protruding portion, and the excitation coil is installed between the inner protruding portion and the heat-insulating base plate.

Preferably, a radial length of a cross section of a wire of the excitation coil is greater than a thickness length in a centerline direction of the wire. In such a way, the energy is saved, and the heating efficiency is high, which facilitates the eddy current induction on the electromagnetic induction element.

As a second aspect of the present invention, an electromagnetic heating device for hookah includes an electromagnetic heater and an electromagnetic induction element, wherein the electromagnetic induction element is installed at a hookah bowl, the electromagnetic heater comprises a shell and an electromagnetic heating body installed in the shell, the shell comprises a heat-insulating base plate, the electromagnetic heater is installed above the hookah bowl, and the heat-insulating base plate is faced against an opening of the hookah bowl; the electromagnetic heating body comprises an excitation coil and a drive circuit, the excitation coil is in a shape of a sheet and formed by spiraling a wire outward from a center, the excitation coil is configured to face the heat-insulating base plate and send out a high-frequency AC signal by which an eddy current effect is produced on the electromagnetic induction element to the heat-insulating base plate, under a control of the drive circuit.

Preferably, the electromagnetic induction element is a tin foil wrapped on a rim of the hookah bowl or a metal sheet installed on the rim of the hookah bowl or an electromagnetic induction sheet disposed in the hookah bowl, the tin foil or the metal sheet has a plurality of air holes, and the electromagnetic induction element is configured to heat tobacco in the hookah bowl to generate smoke.

Preferably, the electromagnetic induction element is installed on a rim of the hookah bowl and provided with a recess for holding tobacco, a plurality of air holes are provided at a bottom of the recess to communicate with the hookah bowl, and the electromagnetic induction element is configured to heat the tobacco in the hookah bowl to generate smoke which enters to the hookah bowl then into a hookah bottle via the air holes. Preferably, the electromagnetic induction element is movably supported on the opening of the hookah bowl where is provided with a plurality of air holes, the electromagnetic heater is movably arranged on the electromagnetic induction element and provided with a plurality of air inlets to communicate with the external environment and the air holes respectively; and the electromagnetic induction element is configured to heat tobacco in the hookah bowl to generate smoke. In the present invention, the electromagnetic output part (namely the electromagnetic heater) and the electromagnetic induction part (namely the electromagnetic induction part) are two independent parts, which are detachably connected or completely independent. The magnetic induction parts may be removed separately for cleaning, which is convenient for cleaning and easy to replace. Furthermore, the electromagnetic induction element of the present invention is directly movable and supported on the hookah bowl, and there is no need to use additional element such as a sealing cover to seal the hookah bowl, which is convenient to use.

Preferably, the electromagnetic induction elements are tinplate stamping sheets, stainless steel sheets or stainless iron sheets.

Preferably, a periphery of the heat-insulating base plate is provided with a plurality of support legs, and the support legs are supported on a periphery of the electromagnetic induction element, and the air inlets are formed between two adjacent support legs.

Preferably, a peripheral edge of the electromagnetic induction element is supported on a rim of the opening of the hookah bowl to close the opening, a middle of the electromagnetic induction element is recessed downward to form a heating portion which is inserted into the hookah bowl, the air holes are formed on the heating portion; a heating chamber is defined between the heat-insulating base plate and the heating portion, and the air inlets are formed between the heat-insulating base plate and the electromagnetic induction element, one end of the heating chamber is connected to the air inlets, and another end of the heating chamber is connected to the air holes; when smokes, external air enters the heating chamber through the air holes, and is heated by the electromagnetic induction element in the heating chamber and then enters the hookah bowl from the air holes.

In comparison with the prior arts, an electromagnetic heater is proposed for heating tobacco products (shredded tobacco, tobacco paste, etc.). When in use, a tin foil may be wrapped on a hookah bowl in a traditional way as an electromagnetic induction element, or an electromagnetic induction element is supported on or disposed in the hookah bowl, and an electromagnetic heater is configured on the hookah bowl and is energized to the excitation coil to cause the electromagnetic induction element to produce an eddy current effect, so that the electromagnetic induction element is heated up to burn the tobacco products. On the one hand, the electromagnetic induction element is heated by the electromagnetic heater, which has high heating efficiency and requires small power for the power supply. On the other hand, the excitation coil is in the shape of a sheet and is formed by spiraling a wire outward from a center, which promotes an eddy current effect produced on an electromagnetic induction element to heat efficiently. Without additional thermal conductive components. Moreover, the electromagnetic induction element is heated by receiving high-frequency electromagnetic signal from the electromagnetic heater, no additional physical circuit is connected, which greatly improves the stability and reliability of the system.

### BRIEF DESCRIPTION OF THE DRAWINGS

FIG. 1 is a structural diagram of a traditional hookah.

FIG. 2 is a perspective view of an electromagnetic heater according to one embodiment of the present invention.

FIG. 3 is a plan view of the electromagnetic heater according to one embodiment of the present invention.

FIG. 4 is an exploded perspective view of the electromagnetic heater according to one embodiment of the present invention.

FIG. 5 is a structural diagram of the excitation coil and the electromagnetic shielding sheet installed together according to the present invention.

FIG. 6 is a structural diagram of the excitation coil and the electromagnetic shielding sheet installed together according to the present invention.

FIG. 7a is a structural block diagram of the electromagnetic heater of the present invention.

FIG. 7b is a structural diagram of a drive circuit according to one embodiment of the present invention.

FIG. 7c is a structural diagram of a drive circuit according to another embodiment of the present invention.

FIG. 7d is a structural diagram of a drive circuit according to another embodiment of the present invention.

FIG. 7e is a circuit diagram of a main circuit of the electromagnetic heating device for hookah of the present invention.

FIG. 8 is a structural diagram of an electromagnetic heating device for hookah installed on a hookah according to a first embodiment of the present invention.

FIG. 9 is a side view of the electromagnetic heating device for hookah in the first embodiment of the present invention.

FIG. 10 is a structural diagram of an electromagnetic induction element in the first embodiment of the present invention.

FIG. 11 is a structural diagram of an electromagnetic heating device for hookah installed on a hookah according to a second embodiment of the present invention.

FIG. 12 is a structural diagram of an electromagnetic heating device for hookah installed on a hookah according to a third embodiment of the present invention.

FIG. 13 is a structural diagram of an electromagnetic heating device for hookah installed on a hookah in another embodiment different from the first embodiment of the present invention.

FIG. 14 is a structural diagram of an electromagnetic heating device for hookah installed on a hookah according to the second embodiment of the present invention.

FIG. 15 is a structural diagram of an electromagnetic heating device for hookah installed on a hookah according to the third embodiment of the present invention.

### DETAILED DESCRIPTION OF ILLUSTRATED EMBODIMENTS

In order to make the purpose, technical solutions and advantages of the present application more clearly understood, the present application will be described in further detail below with reference to the accompanying drawings and embodiments. It should be understood that the specific embodiments described herein are only used to explain the present application, but not to limit the present application. The same reference numbers in different figures represent the same parts.

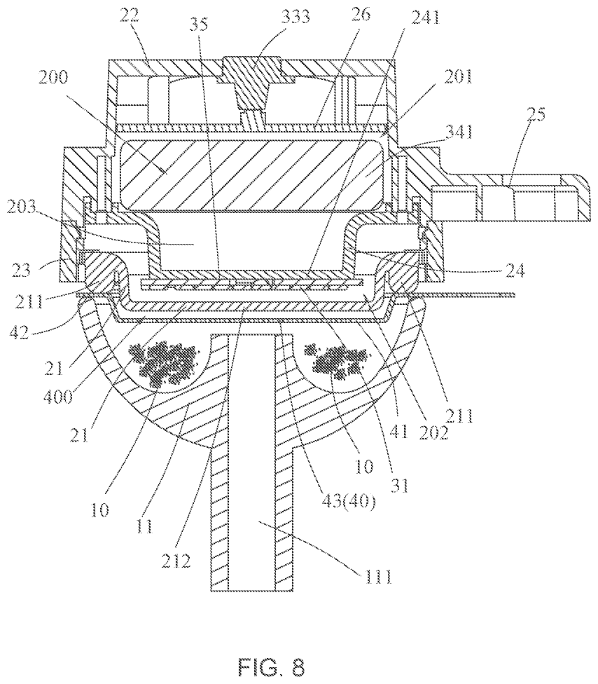

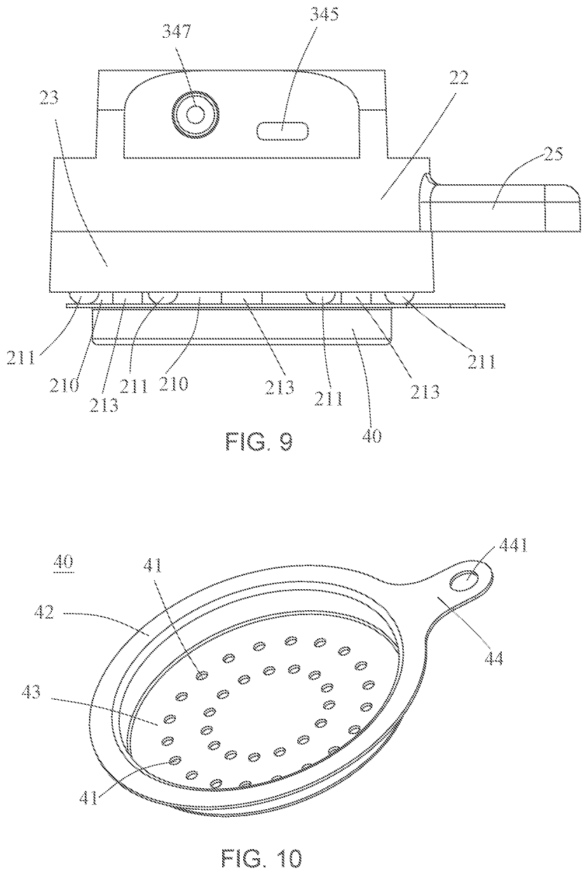

Referring to FIGS. 8 and 9, an electromagnetic heating device for hookah of the invention includes an electromagnetic heater 200 and an electromagnetic induction element 40. Specifically, the electromagnetic induction element 40 is configured to install on a hookah bowl 11 of a hookah and contact with tobacco (such as tobacco shred or tobacco paste) in the hookah bowl 11. The electromagnetic heater 200 includes an excitation coil 31 and a drive circuit 32 which is configured to drive the excitation coil 31 to emit a high-frequency AC signal to produce eddy current effect on the electromagnetic induction element 40.

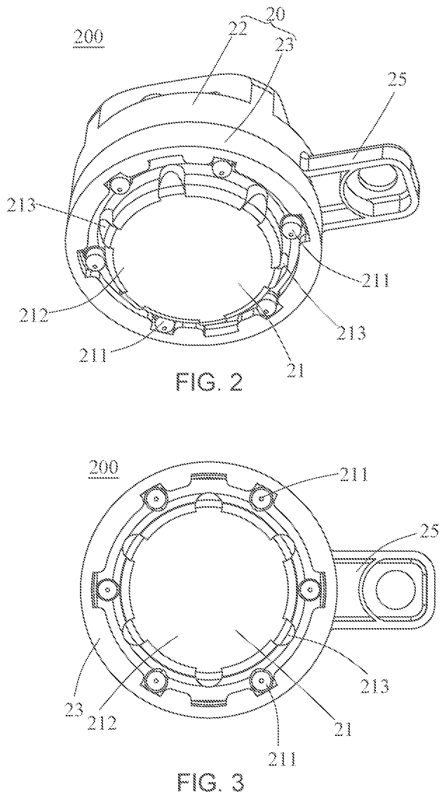

Referring to FIGS. 2-4, the electromagnetic heater 200 includes a shell 20 and an electromagnetic heating body 30 installed in the shell 20. The shell 20 includes a heat-insulating base plate 21. The electromagnetic heating body 30 includes the excitation coil 31 and the drive circuit 32. Specifically, the excitation coil 31 is in a sheet form and formed by gradually spiraling a wire outward from a center, in a plane, and an end of the excitation coil 31 is extended towards the heat-insulating base plate 21. The excitation coil 31 is configured to emit a high-frequency AC signal by which an eddy current effect is produced on the electromagnetic induction element to the heat-insulating base plate 21, under a control of the drive circuit 32.

In the present embodiment, the electromagnetic induction element 40 is movably placed on the hookah bowl 11 of the hookah and contact with the tobacco 10 (such as tobacco shred or tobacco paste) in the hookah bowl 11. The electromagnetic heater 200 is movably placed on the electromagnetic induction element 40, and at least one air hole 41 is formed on the electromagnetic induction element 40 where is corresponding to the position of the opening of the hookah bowl 11. As discussed, electromagnetic heater 200 includes the excitation coil 31 and the drive circuit 32, and the excitation coil 31 is configured to emit a high-frequency AC signal by which an eddy current effect is produced on the electromagnetic induction element 40 to the heat-insulating base plate 21, under the control of the drive circuit 32. Specifically, terms “movably placed” or “movably supported” in the present disclosure mean that, the object may be movable in the lateral direction and may be picked up in the longitudinal direction directly, without moving the hookah bowl 11

Referring to FIG. 9, when the electromagnetic heater 200 is movably placed on the electromagnetic induction element 40, at least one air inlet 210 is formed between the electromagnetic heater 200 and the electromagnetic induction element 40, and the air inlet 210 is communicated with the external environment and the air holes 41 respectively. Specifically, a plurality of support legs 211 for supporting the shell are protruded on the heat-insulating base plate 21, and the support legs are supported above the hookah bowl 11, and furthermore the air inlet 210 is formed between the heat-insulating base plate 21 and the hookah bowl 11 and communicated with the inside of the hookah bowl 11. The support legs 211 may be located at an edge position of the heat-insulating base plate 21, or located at the middle position of the heat-insulating base plate 21, if only the heat-insulating base plate 21 is suspended above the hookah bowl 11. The electromagnetic induction element 40 is a metal sheet supported above the opening of the hookah bowl 11.

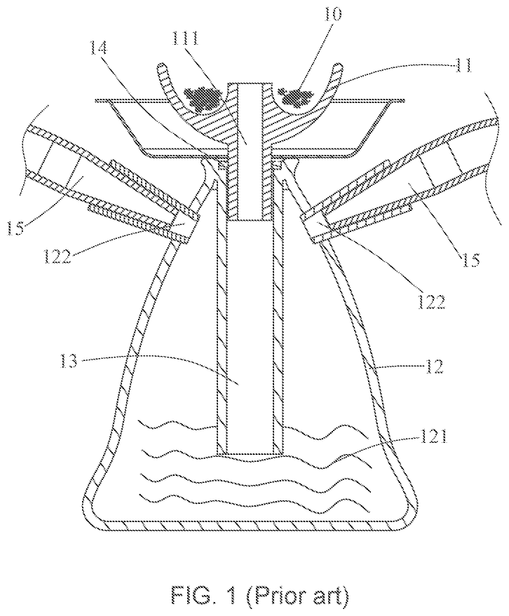

Referring to FIGS. 1-8, a distance is formed between the electromagnetic induction element 40 and the ventilation pipe 111 in the hookah bowl 11. When smoking, the drive circuit 32 drives the excitation coil 31 to send out a high-frequency AC signal to produce an eddy current effect on the electromagnetic induction element 40, so that the electromagnetic induction element 40 heats the tobacco 10 to generate smoke accordingly. When smokes, air enters the air holes 41 from the air inlet 210, and enters the hookah bowl 11, causing the smoke generated in the hookah bowl 11 to enter the smoke ventilation pipe 111 and into the filtering pipe 13, the smoke is filtered and then is sucked through the pipes 122 and 15.

Referring to FIGS. 8 and 10, in this embodiment, the electromagnetic induction element 40 mounted on the hookah bowl 11 includes a peripheral edge 42 and a heating portion recessed in the middle. Specifically, the peripheral edge 42 is supported on the rim of the opening of the hookah bowl 11 to prevent the smoke from overflowing. The heating portion 43 is recessed, thus the electromagnetic induction element 40 is in a cover form to cover the opening of the hookah bowl 11. In this embodiment, the heating portion 43 is a circular recess, which may be other shapes.

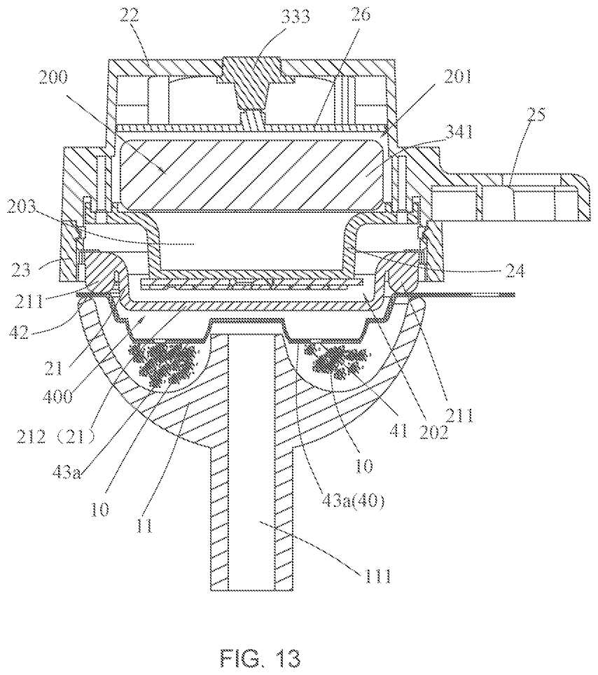

For example, referring to FIG. 13, the heating portion 43a is in a shape of ringed recess. In this case, the heating portion 43a may be reached above or beneath the top of the pipe 111. In this embodiment, the electromagnetic induction element 40 may be formed in an integral structure, that is, the peripheral edge 42 and a heating portion 43/43a are made of integral materials. Alternatively, the electromagnetic induction element 40 may be formed by different materials, and the heating portion 43a also may be formed by different materials, such as that portion facing against the pipe 111 is made of non-magnetic and heat-resistant material, such as ceramic.

Specifically, the electromagnetic induction element 40 further includes a handle 44 extending from the peripheral edge 42, by which the user can remove the electromagnetic induction element 40 from the hookah bowl 11 via a clamp for example. Preferably, a hole 441 may be provided on the handle 44 to hang the removed electromagnetic induction element 40.

In this embodiment, the electromagnetic induction element 40 is formed by stamping a metal sheet (e.g., a tinplate sheet, a stainless steel sheet, a stainless iron sheet, etc.), and may also be other electromagnetic induction materials or materials mixed with metal.

Referring to FIG. 8, a heating chamber 400 is defined between the heat-insulating base plate 54 and the heating portion 43 of the electromagnetic induction element 40. One end of the heating chamber 400 is connected to the air inlet 21, and the other end is connected to the air holes 41. When smokes, the external air enters the heating chamber 210 through the air holes 41, and is heated by the electromagnetic induction element 40 in the heating chamber 210 and then enters the hookah bowl 11 from the air holes 41. When the electromagnetic heater 200 is disposed on the electromagnetic induction element 40 and then energized, the electromagnetic induction element 40 will generate eddy current effect to produce heat. Therefore, the air in the heating chamber 400 will be heated due to the electromagnetic induction element 40, which improves the smoking experience and maintains a sufficient and stable temperature in the bowl 11 because warm air enters to the bowl 11, and meanwhile the combustion of the tobacco 10 is stable.

In another embodiment, the periphery 42 of the electromagnetic induction element 40 may has a lower flange which is bent downward to wrap the periphery of the hookah bowl 11, and the handle 44 is formed at the end of the lower flange.

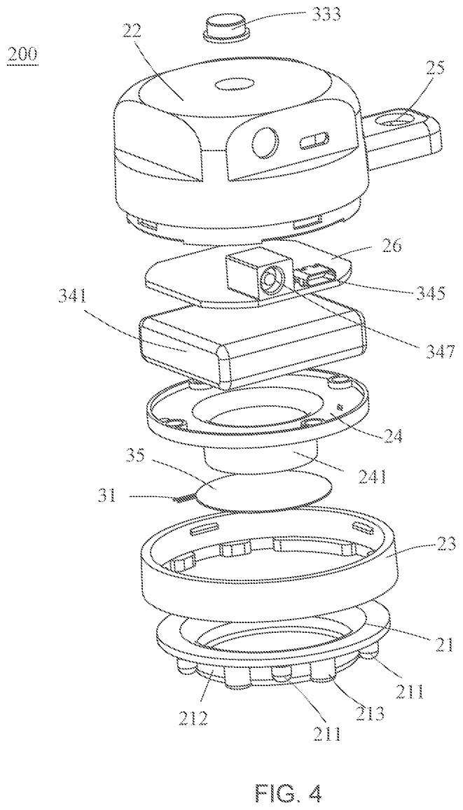

Referring to FIGS. 2 and 3, the support legs 211 are distributed around a center of the heat-insulating base plate 21, and a heating area corresponding to a position of the excitation coil 31 is formed around the support legs 211. Specifically, the support legs 211 are arranged near the peripheral edge of the heat-insulating base plate 21.

Referring to FIGS. 2, 3 and 8, an outer protruding portion 212 is protruded from the middle of the heat-insulating base plate 21, and a backside of the outer protruding portion 212 is recessed to accommodate the excitation coil 31.

Specifically, the outer protruding portion has a horizontal plane lower than ends of the support legs 211, the support legs 211 are configured near an outer edge of the heat-insulating base plate 21 and distributed around the center of the heat-insulating base plate 21, and the outer protruding portion 212 is extended into the hookah bowl 11 when the support legs 211 are supported on the hookah bowl 11.

In this embodiment, the support legs 211 are supported on the peripheral edge 42 of the electromagnetic induction element 40, and the outer protruding portion 212 inserts into the recess of the heating portion 43 to engage with the heating portion 43. Specifically, the radius of the outer protruding portion 212 is smaller than that of the heating portion 43, and the distance from the outer protruding portion 212 to the end of the support legs 211 is smaller than the depth of the heating portion 43.

Referring to FIGS. 2 and 3, multiple guide bumps 213 are provided along a periphery of the outer protruding portion 212, the guide bumps 213 and the support legs 211 are arranged in a staggered manner; a distance between outer sides of the guide bumps 213 and the center of the heat-insulating base plate 21 is greater than or equal to that between inner sides of the support legs 211 and the center of the heat-insulating base plate 21, and is less than that between outer sides of the support legs 211 and the center of the heat-insulating base plate 21, and an outer end of each guide bump 213 is inclined to form a guide wall (as shown in FIG. 2, the guide wall is used for guiding the outer protruding portion 212 into the pitch of the heating portion 43).

Specifically, a guide channel is formed between adjacent guide bumps 213, and extended along the centerline direction (longitudinal direction) of the hookah bowl 11. The heating cavity 400 is formed between the outer protruding portion 212 and the heating portion 43, and multiple guide channels are located above the outer side of the heating chamber 400. In such a way, the air needs to descend from the air inlet for a period of time to enter the heating chamber 400 horizontally. The air inlet 210 is located above the outside of the heating chamber 400, and the guide channels are extends from top to bottom. In the present embodiment, the guide channels are longitudinal channels from top to bottom, and do not extend axially on the outer protruding portion 212. In other embodiments, the guide channels may be spiral channels spiraling outside the outer protruding portion.

In this embodiment, the bottom of the heating portion 43 of the electromagnetic induction element 40 is a flat sheet parallel to the opening of the hookah bowl 11, and the position of the bottom shell 21 opposite to the heating portion 43 is flat, so that the heating chamber 400 is flat. Of course, the bottom of the heating portion 43 of the electromagnetic induction element 40 may be in the shape of a cone, a downwardly inclined triangle, a cone, or a sphere, etc., which is not limited.

Preferably, the electromagnetic heating body 30 further includes a control unit 33 for controlling operations of the drive circuit 32 and a power supply unit for supplying power to the drive circuit 32.

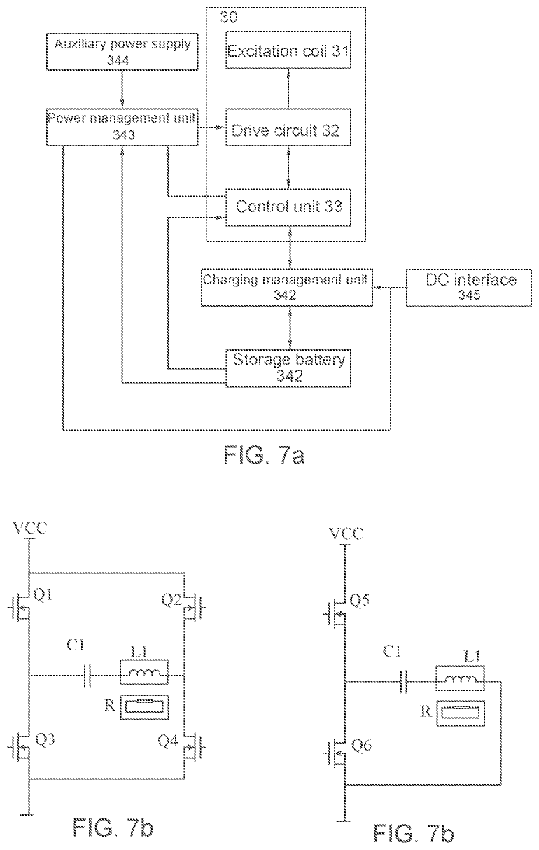

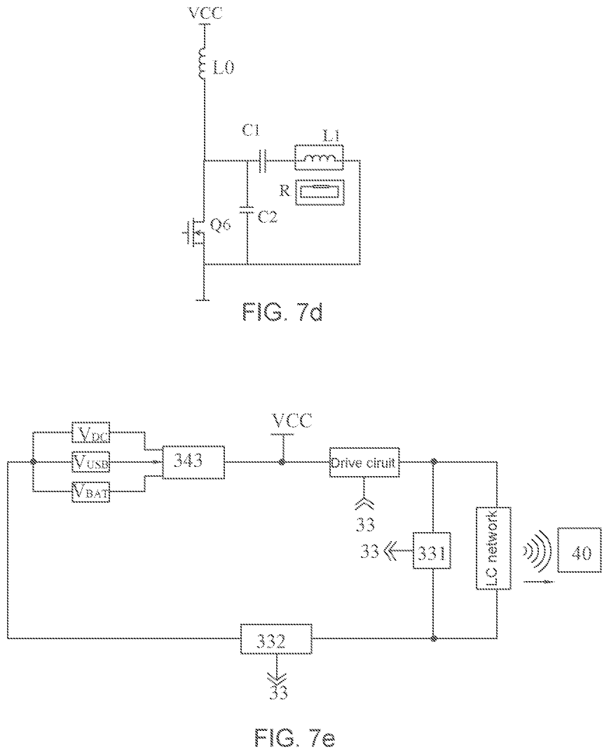

Referring to FIG. 7a, a circuit block diagram of the electromagnetic heating body 30 of the present invention is shown. As illustrated, the power supply unit includes a storage battery 341, a charging management unit 342, a power management unit 343, and a DC interface 345. Specifically, the DC interface 345 is connected to the storage battery 341 through the charging management unit 342, and the charging management unit 342 is configured to manage the charging and discharging of the storage battery 341. The power management unit 343 is configured to convert the electrical energy in the storage battery into a corresponding voltage and send it to the drive circuit 32 to supply power.

More specifically, the power supply unit also includes an auxiliary power supply 344 connected to the power management unit 343 through a power supply interface 347, by which the external commercial power is converted into a power supply voltage and sent to the power supply management unit 343. The power management unit 343 is configured to convert the power supply voltage into a working power supply voltage for driving the drive circuit 32.

More specifically, the DC interface 345 is further connected to the power management unit 343 which is configured to convert the electrical energy input from the DC interface 345 into a working voltage and send it to the drive circuit 32. The DC interface 345 may be a DC power supply interface such as a standard USB interface, a micro USB interface, or a type-c interface. In this embodiment, the storage battery 341 is a lithium battery.

Three power input modes such as auxiliary power supply, DC interface power supply, and battery power supply are included in the present embodiment. The control unit 33 is connected to the power management unit 343 to control the power management unit 343 to select the power input mode according to the priority, and the priority from high to low is auxiliary power supply, DC interface power supply, and battery power supply. The power management unit 343 is configured to design different topologies according to different input voltages, such as a pass-through mode, a boost mode, a buck mode, and a buck-boost mode.

Referring to FIG. 7e, a circuit schematic diagram of the electromagnetic heating body 30 is shown, which includes three power inputs provided by the power supply unit: an auxiliary power supply V_{DC}, a DC interface power supply V_{USB} and a battery power supply V_{BAT}. The power management unit 343 converts the electric energy input by different power input methods into the voltage required by the drive circuit 32, and the drive circuit 32 controls the LC network to output the corresponding high-frequency AC signal under the control of the control unit 33. Specially, the LC network includes a resonant capacitor and a resonant inductor (excitation coil 31) that are in series, and the LC network is configured to send a high-frequency AC signal to the electromagnetic induction element 40 to generate an eddy current effect on the element 40, thereby generating heat. Additionally, the electromagnetic heating body 30 has a voltage detection circuit 331 and a current detection circuit 332 for collecting the voltage across the LC network and the current on the excitation coil 31 respectively, which are then transmitted to the control unit 33.

When the high-frequency AC signal is sent to the electromagnetic induction element 40, an induced current is generated on the electromagnetic induction element 40. In this disclosure, the resistivity of the electromagnetic induction element 40 changes with the temperature, specifically, the resistivity of the electromagnetic induction element 40 has a linear change with temperature within a normal temperature range, and the change relationship is expressed as ρ=ρ0(1+αt), where ρ and ρ represent a resistivity at the current temperature t° C. and 0° C., respectively; α represents a temperature coefficient of the resistivity of the electromagnetic induction element 40, and t represents a temperature value of the electromagnetic induction element. That is to say, the change of the resistance of the electromagnetic induction element 40 has a linear relationship with the change of the temperature, expressed as t=(R−R0)/(R0*α) where R and R0 represent resistance values at the current temperature t° C. and 0° C., respectively, and α represents a temperature coefficient of the resistivity of the electromagnetic induction element 40. According to the formula, it can be concluded that, when the temperature rises, the resistance of the electromagnetic induction element 40 will increase accordingly; thus, the loop current of the LC network is will also decrease, and the power fed back to the drive circuit 32 will decrease accordingly. That is to say, the power of the drive circuit where the LC network is located is also reduced, and as known that power has a linear relationship with the temperature of the electromagnetic induction element 40. According to the power calculation formula P=UI, it is obtained that the temperature of the electromagnetic induction element 40 can be calculated as long as the power of the drive circuit is calculated. In the memory of the control unit 33, current values, voltage values, power values, temperature coefficients, preset temperature, etc. of the drive circuit are stored. After the entire system starts to work, the control unit 33 obtains the current and voltage in the drive circuit detected by the voltage detection circuit 331 and the current detection circuit 332 and calculates the power of the drive circuit, and then calculates the temperature of the electromagnetic induction element 40 according to the temperature coefficients. Once the temperature is greater than the preset temperature, and the control unit 33 controls the drive circuit 32 to stop outputting the control signal to the LC network, and the electromagnetic induction element 40 stops heating. When the temperature of the electromagnetic induction element 40 is lower than the preset temperature, the drive circuit 32 continues to output a control signal to the LC network, and the electromagnetic induction element 40 continues to heat, thereby performing the temperature control.

Preferably, during the temperature control process, the detected temperature of the electromagnetic induction element 40 is integrated in real time. An upper limit and a lower limit of the temperature integration are pre-determined. A smoking behavior will be determined to happen once the temperature integration rapidly exceeds the upper limit, then the number of puffs is started to count.

Specifically, the control unit 33 includes an MCU, a switch button 333 and a detection circuit. A start command can be input by pressing the switch button 333, and the MCU is started upon commands to control the operation of the drive circuit 32. Of course, the MCU is also configured to detect an existence of an electromagnetic induction element through the detection circuit. If yes, the MCU is started; otherwise, the MCU enters a standby state. The detection circuit includes a voltage detection circuit 331 and a current detection circuit 332, and the MCU can determine the existence of the electromagnetic induction element via the voltage and current collected by the voltage detection circuit 331 and the current detection circuit 332. The MCU, the switch button 333, the detection circuit and the drive circuit 32 are all mounted on the circuit board 26.

Referring to FIG. 7b, in one embodiment, the drive circuit 32 is a full-bridge drive circuit, which can greatly improve the work efficiency and save energy.

The drive circuit 32 consists of a MOS transistor Q1, a MOS transistor Q2, a MOS transistor Q3, and a MOS transistor Q4, and forms a main circuit of a high-frequency signal generating circuit with the LC network. The LC network consists of a resonant capacitor C1 and a resonant inductor L1. The resonant inductance L1 is an equivalent inductance of the excitation coil 31, and R is the equivalent resistance of the electromagnetic induction element 40, which is used to receive the high-frequency AC signal sent by the inductance L1 to generate heat. Specifically, the LC network is a series resonant network, and the resonant frequency is: f0=½π \sqrt{L1C1}When the control unit 33 controls the drive circuit 32 to cause the frequency of the driving signal f=f0, resonance will be generated on the circuit. The time sequence follows: for positive half-cycle, the current flows as below: VCC->Q1->C1->L1->Q4->GND; for negative-half cycle, the current flows as below: VCC->Q2->L1->C1->Q3->GND.

Referring to FIG. 7c, in another embodiment, the drive circuit 32 may be a half-bridge drive circuit.

Specifically, the drive circuit 32 consists of a MOS transistor Q5 and a MOS transistor Q6, and forms a main circuit of a high-frequency signal generating circuit with the LC network. The LC network consists of a resonant capacitor C1 and a resonant inductor L1. The resonant inductance L1 is an equivalent inductance of the excitation coil 31, and R is the equivalent resistance of the electromagnetic induction element 40, which is used to receive the high-frequency AC signal sent by the inductance L1 to generate heat. Specifically, the LC network is a series resonant network, and the resonant frequency is: f0=½π\sqrt{L1C1}. When the control unit 33 controls the drive circuit 32 to cause the frequency of the driving signal f=f0, resonance will be generated on the circuit. The time sequence follows: for positive half-cycle, the current flows as below: VCC->Q1->C1->L1->GND; for negative half-cycle, the current flows as below: L1->C1->L1->02->GND.

Referring to FIG. 7d, in one more embodiment, the drive circuit 32 is an amplifier circuit of Class E.

Specifically, the drive circuit consists of MOS transistor Q7, a capacitor C2 and a high-frequency choke coil L0, and forms a main circuit of a high-frequency signal generating circuit with a LC network. The LC network consists of a resonant capacitor C1 and a resonant inductor L1. The resonant inductance L1 is an equivalent inductance of the excitation coil 31, and R is the equivalent resistance of the electromagnetic induction element 40, which is used to receive the high-frequency AC signal sent by the inductance L1 to generate heat. Specifically, the LC network is a series resonant network, and the resonant frequency is: f0=½π\sqrt{L1C1}. When the control unit 33 controls the drive circuit 32 to cause the frequency of the driving signal f=f0, resonance will be generated on the circuit.

Referring to FIGS. 4 and 8, the shell 20 includes a top shell 22, a bottom shell 23, and an isolation cover 24 installed between the top shell 22 and the bottom shell 23, a first chamber 201 for installing the control unit 33 and the power supply unit is formed between the top shell 22 and the isolation cover 24, and a second chamber 202 for installing the excitation coil 31 is formed between the isolation cover 24 and the bottom shell 23, and the first chamber 201 is isolated from the second chamber 202 by the isolation cover 24, and the bottom wall of the bottom shell 23 is formed from a part of the heat-insulating base plate 21. Due to the isolation cover 24, the control power supply part and the electromagnetic generating part (namely the excitation coil 31) of the electromagnetic heating body 30 can be effectively isolated, thereby reducing the thermal influence and electromagnetic influence between the control power supply part and the electromagnetic generating part (excitation coil) 31).

Referring to FIGS. 4 and 8, the middle of the isolation cover 24 is recessed toward the second chamber 202 to form an isolation chamber 203, different from the first chamber 201, the isolation cover 24 is provided with an inner protruding portion 241 at a backside of the isolation cavity 203, and the excitation coil 31 is installed between the inner protruding portion 241 and the heat-insulating base plate 21.

Referring to FIG. 8, the exciting coil 31 is installed on the inner protruding portion, with a space is formed between the exciting coil 31 and the heat-insulating base plate 21.

In this embodiment, the edge of the isolation cover 24 is provided with several installation positions by which the isolation cover 24 is installed on the top shell 22. The top shell 22 is assembled with the bottom shell 23 by installation components. During the assembly, the control unit 33 and the power supply unit are firstly installed in the top shell 22, and then the isolation cover 24 is installed on the top shell 22 to close the first chamber 201, and then the excitation coil 31 is mounted on the inner protruding portion 241 of the isolation cover 24, and finally the bottom shell 23 is mounted on the top shell 22 to close the second chamber 202.

Referring to FIG. 4 and FIG. 8, the bottom shell 23 includes a ring-shaped fixing frame 230 and the heat-insulating base plate 21 engaged with the ring-shaped fixing frame 230. Referring to FIG. 4, the heat-insulating base plate 21 is made of ceramic. Of course, the heat-insulating base plate 21 can be made of other non-magnetic and non-metal heat insulating materials, such as mica.

In this embodiment, the heat-insulating base plate 21 is made of the same material as an integral structure. In one embodiment, those parts of the heat-insulating base plate 21 contacting with the element 40, namely the support legs 211 are made of high-temperature resistant materials, other parts of the heat-insulating base plate 21 have lower requirements for high temperature resistance.

Referring to FIG. 2 to FIG. 4, a handle 25 for holding is formed on the shell 20.

Referring to FIGS. 5 and 8, an electromagnetic shielding sheet 35 is provided on a side of the excitation coil 31 away from the heat-insulating base plate 21, and the excitation coil 31 is mounted on the electromagnetic shielding sheet 35. Due to the electromagnetic shielding sheet 35, the control power supply in the first chamber 201 will not be affected by the electromagnetic field of the excitation coil 31. Specifically, the electromagnetic shielding sheet 35 can be made of a material with high magnetic permeability, in order to shield the eddy current phenomenon generated by other metal parts.

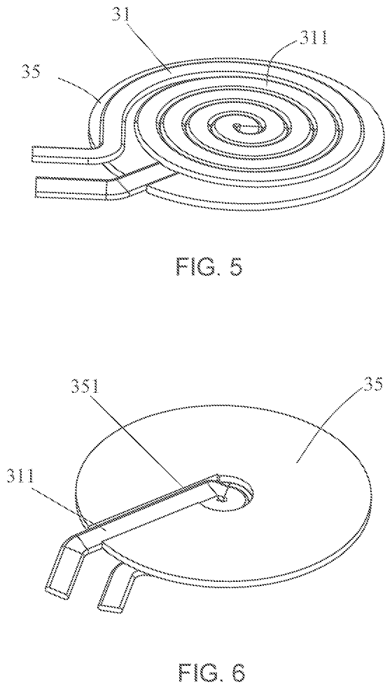

Referring to FIGS. 5 and 6, the electromagnetic shielding sheet 35 is provided with a groove 351 formed from the edge to the center thereof, a first end of the excitation coil 31 is spiraled from the edge to the center, then extended along the groove 351 to lead out a second end.

As shown in FIGS. 5 and 6, a radial length of the cross section of the wire 311 of the excitation coil 31 (namely the length in the width direction) is greater than a thickness length in the centerline direction of the wire 311(namely the length in the thickness direction), and the thickness surface of the wire 311 is opposite to the heat-insulating base plate 21.

Preferably, referring to FIGS. 5 and 6, the wire 311 of the excitation coil 31 is flat (the cross section can be rectangular, oval, etc.), and its flat surface is opposite to the heat insulating base plate 21. Alternatively, the cross section of the wire 311 of the excitation coil 31 may also be triangle, trapezoid, circular or square. The wire 311 of the excitation coil 31 may be one or more conductors wrapped with an insulating layer.

In the above-mentioned embodiments, the heat-insulating base plate 21 of the electromagnetic heater 200 is indirectly supported on the hookah bowl 11 through the electromagnetic induction element 40, and the heat-insulating base plate 21 is engaged with the electromagnetic induction element 40 in a concave-convex matching to limit the position in the radial direction to prevent disengagement.

In the above-mentioned embodiments, the electromagnetic induction element 40 is covered on the hookah bowl 11, and the hookah bowl 11 is communicated with the air of the external environment via the air holes 41.

Specifically, the electromagnetic heater 200 is movably supported on the electromagnetic induction element 40. Different from the above embodiments, the electromagnetic induction element 40 may be directly and detachably connected to the electromagnetic heater 200, in an engagement manner or screw connection manner.

In the above embodiment, a distance is formed between the heat-insulating base plate 21 of the electromagnetic heater 200 and the heating portion 43 of the electromagnetic induction element 40 to define a flat heating cavity 400. Different from the above embodiments, the element 40 and/or the bottom of the heat-insulating base plate 21 is provided with one or more channels (not shown) connected to the air holes 41. One end of a channel is connected to the air inlet 210, and the other end is connected to one or more air holes 41. In such a manner, the air inlet 210 is communicated with the air holes 41 via the channels, without a heating cavity.

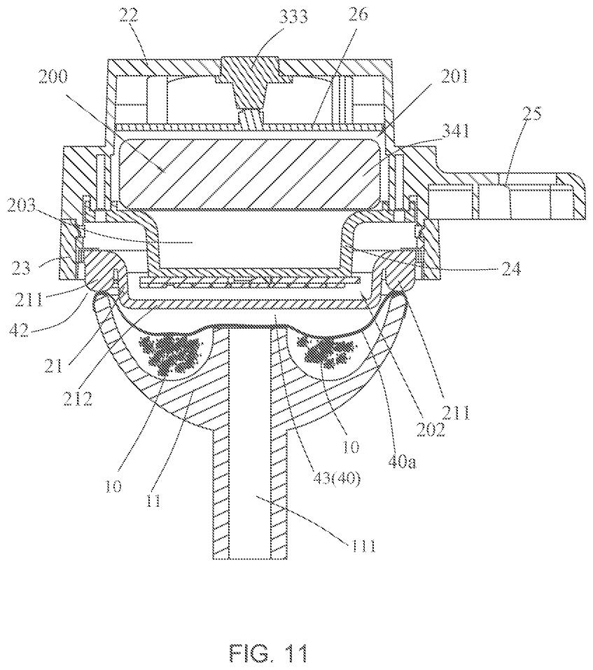

Referring to FIG. 11, different from the above-mentioned embodiments, the electromagnetic induction element 40 in the second embodiment is a tin foil wrapped on the rim of the hookah bowl 11, with multiple air holes are formed on the tin foil. The heat-insulating base plate 21 of the electromagnetic heater 200 is directly supported on the rim of the opening of the hookah bowl 11, and the outer protruding portion 212 of the heat-insulating base plate 21 is matched with the rim of the opening of the hookah bowl 11 (specifically the guide bumps 213 are pressed against the inner rim of the hookah bowl 11), to prevent the heat-insulating base plate 21 sliding out of the hookah bowl 11 in the radial direction.

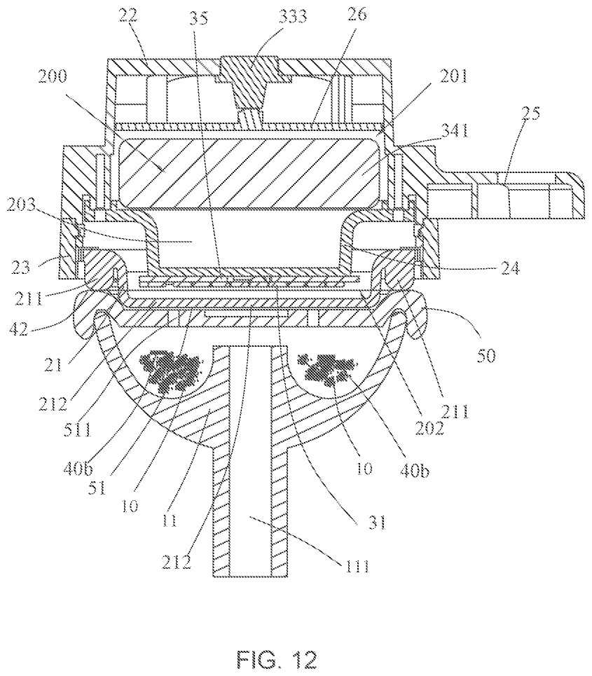

Referring to FIG. 12, different from the above-mentioned embodiments, the electromagnetic heater in the third embodiment further includes a heat-resistant cover 50 removable from the hookah bowl 11. An upper surface of the heat-resistant cover 50 is recessed to form an accommodating cavity 51, a bottom wall of the accommodating cavity 51 is provided with a through hole 511, a center of the heat-insulating base plate 21 is provided with an outer protruding portion 212 that is matched with the accommodating cavity 51, the shell 20 is movably supported on the heat-resistant cover 50, the outer protruding portion 212 is extended into the accommodating cavity 51, and an air inlet is formed between the heat-resistant cover 50 and the heat-insulating base plate 21 to communicate with external environment, and the air inlet is communicates with the through hole 511.

In this embodiment, the heat-resistant cover 50 is made of ceramic, and also can be made of other non-magnetically insulating and non-metallic materials, as long as it has good heat-resisting performance.

In this embodiment, the heat-insulating base plate 21 is movably supported on the heat-resistant cover 50. In another embodiment, the heat-insulating base plate 21 may be connected to the heat-resistant cover 50 via fixed connection, engagement connection or other connections. Preferably, the heat-resistant cover 50 is provided with a channel formed from the edge to the center to communicate with the air hole 511 and the air inlet, respectively.

In other embodiments, the heat-insulating base plate 21 may be in a form of a cover to directly support and cover the hookah bowl 11, and an air passage communicating with the outside is opened at a corresponding position of the hookah bowl 11.

In other embodiments, the depth of the accommodating cavity 51 of the heat-resistant cover 50 is greater than the distance from the support legs 211 to the outer protruding portion 212, so that a thermal insulation chamber can be formed between the outer protruding portion 212 and the accommodating cavity 51 when the heat-insulating base plate 21 is supported on the heat-resistant cover 50.

In the present embodiment of FIG. 12, the electromagnetic induction element 40b is a metal sheet or metal ring freely placed in the hookah bowl 11, which is a disposable appliance or a non-long-term appliance that can be used several times.

Optionally, the electromagnetic induction element 40b may be provided with several holes to facilitate the tobacco product burning, when the electromagnetic induction element 40b has large area.

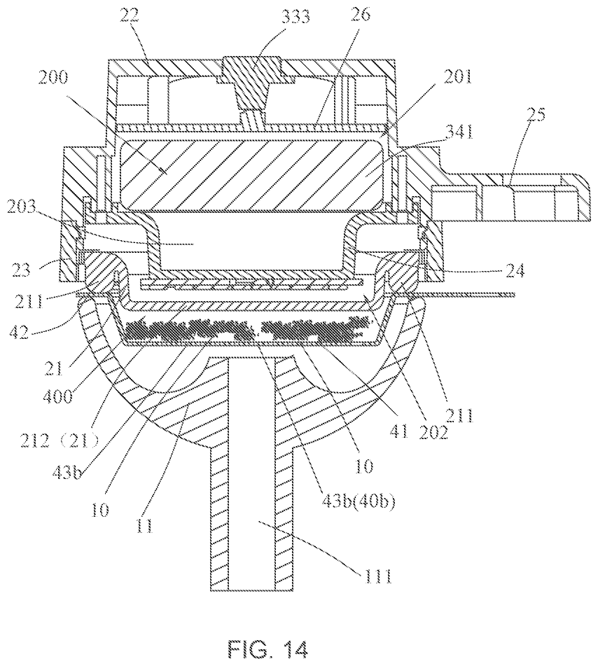

Referring to FIG. 14, different from the above embodiments, the electromagnetic induction element 40b in the fourth embodiment is installed on the rim of the hookah bowl 11 and provided with a recess 43b for holding tobacco 10, and an air hole 41 is provided at a bottom of the recess 43b to communicate with the inside of the hookah bowl 11. Air enters the recess 43b to facilitate the burning of the tobacco 10, and then the smoke enters the hookah bowl 11 via the air holes 41 to enter the hookah 12 via the ventilation pipe 111.

Specifically, a space is formed between the electromagnetic induction element 40b and the ventilation pipe 111 in the hookah bowl 11. The recess 43b is also served as a heating portion 43b of the electromagnetic induction element 40b.

Preferably, the heat-insulating base plate 21 of the electromagnetic heater 200 is supported on the electromagnetic induction element 40b, and air inlets are formed between the electromagnetic induction elemen 40b and the outside (namely between the adjacent support legs 211), and the air inlets are also communicated with the recess 43b. The heating portion 43b is matched with the outer protruding portion 211.

In order to prevent the smoke from overflowing, the heat-insulating base plate 21 of the electromagnetic heater 200 is supported on the electromagnetic induction element 40b and also covers the recess 43b.

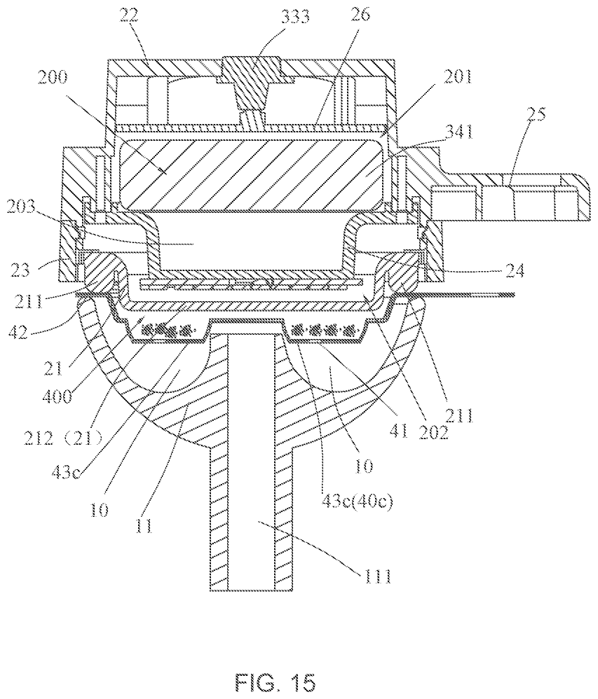

Referring to FIG. 15, different from the above embodiments, the electromagnetic induction element 40c in the fifth embodiment is provided with a recess 43c for holding tobacco 10, the recess 43c is a ring shape, and an air hole 41 is provided at a bottom of the recess 43c to communicate with the inside of the hookah bowl 11. Air enters the recess 43c to facilitate the burning of the tobacco 10, and then the smoke enters the hookah bowl 11 via the air holes 41 to enter the hookah 12 via the ventilation pipe 111.

Specifically, a space is formed between the electromagnetic induction element 40c and the ventilation pipe 111 in the hookah bowl 11. The recess 43b is also served as a heating portion of the electromagnetic induction element 40c.

Preferably, the heat-insulating base plate 21 of the electromagnetic heater 200 is supported on the electromagnetic induction element 40c, and air inlets are formed between the electromagnetic induction element 40c and the outside (namely between the adjacent support legs 211), and the air inlets are also communicated with the recess 43c.

In order to prevent the smoke from overflowing, the heat-insulating base plate 21 of the electromagnetic heater 200 is supported on the electromagnetic induction element 40c and further covers the recess 43c.

Preferably, the electromagnetic induction element 40c may be formed in an integral structure, that is, the peripheral edge and the heating portion 43c are made of integral materials. Alternatively, the electromagnetic induction element 40c may be formed by different materials, and the heating portion 43c also may be formed by different materials, such as that portion facing against the pipe 111 is made of non-magnetic and heat-resistant material, such as ceramic.

Alternatively, the electromagnetic heater 200 in the first embodiment can be directly supported on the hookah bowl 11, and the electromagnetic induction element 40 can be freely placed inside the hookah bowl 11, so that the electromagnetic induction element 40 can be heated by the electromagnetic heater 200. Further, the heat-insulating base plate 21 of the electromagnetic heater 200 covers on the hookah bowl 11, and at least one air inlet 211 is formed therebetween.

The above-mentioned embodiments only represent several embodiments of the present application, and the descriptions thereof are relatively specific and detailed, but should not be construed as limiting the scope of the patent application. It should be pointed out that for those skilled in the art, several modifications and improvements can be made without departing from the concept of the present application, which all belong to the protection scope of the present application. Therefore, the scope of protection of the patent of the present application shall be subject to the appended claims.

What is claimed is:

1. An electromagnetic heater for heating hookah, comprising a shell and an electromagnetic heating body installed in the shell, the shell comprising a heat-insulating base plate, and the electromagnetic heating body comprising an excitation coil and a drive circuit, the excitation coil being in a shape of a sheet and formed by spiraling a wire outward from a center, the excitation coil being configured to face the heat-insulating base plate and send out a high-frequency AC signal by which an eddy current effect is produced on an electromagnetic induction element to the heat-insulating base plate, under a control of the drive circuit.

2. The electromagnetic heater as claimed in claim 1, wherein a plurality of support legs for supporting the shell are protruded on the heat-insulating base plate, the support legs are supported on a hookah bowl, and an air inlet is formed between the heat-insulating base plate and the hookah bowl and communicated with the hookah bowl.

3. The electromagnetic heater as claimed in claim 2, wherein the support legs are configured near an outer edge of the heat-insulating base plate and distributed around a center of the heat-insulating base plate, and a heating area is defined on the heat-insulating base plate.

4. The electromagnetic heater as claimed in claim 2, wherein an outer protruding portion is protruded from a middle of the heat-insulating base plate, and a backside of the outer protruding portion is recessed to accommodate the excitation coil.

5. The electromagnetic heater as claimed in claim 4, wherein the outer protruding portion has a horizontal plate lower than ends of the support legs, the support legs are configured near an outer edge of the heat-insulating base plate and distributed around a center of the heat-insulating base plate, and the outer protruding portion is inserted into the hookah bowl when the support legs are supported on the hookah bowl.

6. The electromagnetic heater as claimed in claim 5, wherein multiple guide bumps are provided along a periphery of the outer protruding portion, the guide bumps and the support legs are arranged in a staggered manner; a distance between an outer side of each guide bump and a center of the heat-insulating base plate is greater than or equal to that between an inner side of each support leg and the center of the heat-insulating base plate, and is less than that between an outer side of each support leg and the center of the heat-insulating base plate, and an outer end of each guide bump is inclined to form a guide wall.

7. The electromagnetic heater as claimed in claim 1, further comprising a heat-resistant cover removable from the hookah bowl, wherein an upper surface of the heat-resistant cover is recessed to form an accommodating cavity, a bottom wall of the accommodating cavity is provided with a through hole, a middle of the heat-insulating base plate is provided with an outer protruding portion that is engaged with the accommodating cavity, the shell is movably supported on the heat-resistant cover, the outer protruding portion is inserted into the accommodating cavity, and an air inlet is formed between the heat-resistant cover and the heat-insulating base plate to communicate with external environment and the through hole, respectively.

8. The electromagnetic heater as claimed in claim 1, wherein the electromagnetic heating body further comprises a control unit for controlling operations of the drive circuit and a power supply unit for supplying power to the drive circuit; the shell comprises a top shell, a bottom shell, and an isolation cover installed between the top shell and the bottom shell, a first chamber for installing the control unit and the power supply unit is formed between the top shell and the isolation cover, and a second chamber for installing the excitation coil is formed between the isolation cover and the bottom shell, and the first chamber is isolated from the second chamber by the isolation cover; the heat-insulating base plate forms a bottom wall of the top shell, and a middle of the isolation cover is recessed toward the second chamber to form an isolation cavity, a side of the isolation cover opposite to the isolation cavity is provided with an inner protruding portion, and the excitation coil is installed between the inner protruding portion and the heat-insulating base plate.

9. The electromagnetic heater as claimed in claim 8, wherein the exciting coil is mounted on the inner protruding portion, with a space is formed between the exciting coil and the heat-insulating base plate.

10. The electromagnetic heater as claimed in claim 1, wherein an electromagnetic shielding sheet is provided on a side of the excitation coil away from the heat-insulating base plate, and the excitation coil is mounted on the electromagnetic shielding sheet.

11. The electromagnetic heater as claimed in claim 10, wherein the electromagnetic shielding sheet is provided with a groove formed from an edge to a center of the electromagnetic shielding sheet, a first end of the excitation coil is spiraled from the edge to the center then extended along the groove to lead out a second end.

12. The electromagnetic heater as claimed in claim 1, wherein a radial length of a cross section of a wire of the excitation coil is greater than a thickness length in a centerline direction of the wire.

13. The electromagnetic heater as claimed in claim 1, wherein the heat-insulating base plate is made of ceramic or mica.

14. An electromagnetic heating device for hookah, comprising an electromagnetic heater and an electromagnetic induction element, wherein the electromagnetic induction element is installed at a hookah bowl, the electromagnetic heater comprises a shell and an electromagnetic heating body installed in the shell, the shell comprises a heat-insulating base plate, the electromagnetic heater is installed above the hookah bowl, and the heat-insulating base plate is faced against an opening of the hookah bowl; the electromagnetic heating body comprises an excitation coil and a drive circuit, the excitation coil is in a shape of a sheet and formed by spiraling a wire outward from a center, the excitation coil is configured to face the heat-insulating base plate and send out a high-frequency AC signal by which an eddy current effect is produced on the electromagnetic induction element to the heat-insulating base plate, under a control of the drive circuit.

15. The electromagnetic heating device as claimed in claim 14, wherein the electromagnetic induction element is a tin foil wrapped on a rim of the hookah bowl or a metal sheet installed on the rim of the hookah bowl or an electromagnetic induction sheet disposed in the hookah bowl, the tin foil or the metal sheet has a plurality of air holes, and the electromagnetic induction element is configured to heat tobacco in the hookah bowl to generate smoke.

16. The electromagnetic heating device as claimed in claim 14, wherein the electromagnetic induction element is installed on a rim of the hookah bowl and provided with a recess for holding tobacco, a plurality of air holes are provided at a bottom of the recess to communicate with the hookah bowl, and the electromagnetic induction element is configured to heat the tobacco in the hookah bowl to generate smoke which enters to the hookah bowl then into a hookah bottle via the air holes.

17. The electromagnetic heating device as claimed in claim 14, wherein the electromagnetic induction element is movably supported on the opening of the hookah bowl where is provided with a plurality of air holes, the electromagnetic heater is movably arranged on the electromagnetic induction element and provided with a plurality of air inlets to communicate with the external environment and the air holes respectively; and the electromagnetic induction element is configured to heat tobacco in the hookah bowl to generate smoke.

18. The electromagnetic heating device as claimed in claim 17, wherein the electromagnetic induction elements are tinplate stamping sheets, stainless steel sheets or stainless iron sheets.

19. The electromagnetic heating device as claimed in claim 17, wherein a periphery of the heat-insulating base plate is provided with a plurality of support legs, and the support legs are supported on a periphery of the electromagnetic induction element, and the air inlets are formed between two adjacent support legs.

20. The electromagnetic heating device as claimed in claim 17, wherein a peripheral edge of the electromagnetic induction element is supported on a rim of the opening of the hookah bowl to close the opening, a middle of the electromagnetic induction element is recessed downward to form a heating portion which is inserted into the hookah bowl, the air holes are formed on the heating portion; a heating chamber is defined between the heat-insulating base plate and the heating portion, and the air inlets are formed between the heat-insulating base plate and the electromagnetic induction element, one end of the heating chamber is connected to the air inlets, and another end of the heating chamber is connected to the air holes; when smokes, external air enters the heating chamber through the air holes, and is heated by the electromagnetic induction element in the heating chamber and then enters the hookah bowl from the air holes.
